(19) United States
(12) Patent Application Publication
(10) Pub. No.: US 2025/0077705 A1
(43) Pub. Date: Mar. 6, 2025

(54) LOCAL DIFFERENTIAL PRIVACY USING STATIC RANDOM-ACCESS MEMORY

(71) Applicant: University of South Alabama, Mobile, AL (US)

(72) Inventors: Na Gong, Mobile, AL (US); Jianqing Liu, Cary, NC (US)

(73) Assignee: University of South Alabama, Mobile, AL (US)

(21) Appl. No.: 18/820,475

(22) Filed: Aug. 30, 2024

Related U.S. Application Data
(60) Provisional application No. 63/536,140, filed on Sep. 1, 2023.

(51) Int. Cl. G06F 21/62

(52) U.S. Cl. CPC G06F 21/6245

(57) ABSTRACT

Techniques for data manipulation based on local differential privacy using static random-access memory are disclosed. Data that requires differential privacy data manipulation is accessed for storage. The data is prepared for storage using key-based shuffling. Keys are selected by a random key index generator. The shuffled data is stored in a static random-access memory (SRAM). The SRAM comprises high-reliability and low-reliability storage cells. A supply voltage of the SRAM is lowered. The lowering a supply voltage produces a pre-characterized noise level in the SRAM storage cells. Cells among the low-reliability cells are flipped based on the pre-characterized noise level. The flipping cells are used to inject random noise, and their values are provided by random noise generators. A read of the stored data is performed. The read occurs across both high-reliability and low-reliability storage cells. The data that was read is unshuffled, using key-based unshuffling.

### RELATED APPLICATIONS

This application claims the benefit of U.S. provisional patent application “Local Differential Privacy Using Static Random-Access Memory” Ser. No. 63/536,140, filed Sep. 1, 2023.

The foregoing application is hereby incorporated by reference in its entirety.

### STATEMENT REGARDING FEDERALLY SPONSORED RESEARCH OR DEVELOPMENT

This invention was made with government support under grant numbers CNS2247273, ECCS2312738, and CNS2211215 awarded by the National Science Foundation. The government has certain rights in the invention.

### FIELD OF ART

This application relates generally to data manipulation and more particularly to local differential privacy using static random-access memory.

### BACKGROUND

Data is the stock-in-trade of nearly all organizations in the 21^{st} century. Data is collected from individuals, groups, devices, web-connected devices, and e-commerce websites, among other sources. The collected data is acquired passively as a user navigates an ecommerce website looking for new window treatments, clothing, or vehicle performance parts. Such data collection ranges from monitoring websites visited, menus selected, and buttons clicked, to actively requesting personal information data and login credentials. The organizations use the collected data for many applications. Some organizations, including research laboratories and academic institutions, analyze the data for scientific purposes. Common scientific purposes include advancing the state of the art of basic science, solving complex problems, and executing rapid responses to emergency situations such as global pandemics. Other organizations analyze the data for market trends to develop investment strategies, to plan renewable energy sources, or to predict the hottest new toy for the upcoming holiday season. Data is also routinely analyzed for political purposes such as advertising strategies and poll data analysis. The data analysis strategies benefit when the amount of data available for analysis is large and the sources of the data are diverse. Yet, the data can be misleading, particularly when the sources of the data have been tampered with. For example, website data collected while a site is under attack can dramatically skew the data and confound the analysis results.

With the nearly global adoption of electronic devices such as personal electronic devices, the sources of data have increased by orders of magnitude. The most widely adopted personal electronic device, the cellular telephone, and in particular the smartphone, enables individuals around the world to communicate using voice, text, and email. These devices are also used for ecommerce purposes such as ordering goods and services and paying for those goods and services. The devices also enable financial services such as online banking, stock trading, and currency exchange. The devices are further used for consuming information such as news, weather, and sports World Cup scores.

Other devices that have become popular for data collection include internet-connected devices. These latter devices, often referred to as the Internet of Things (IoT), include smart thermostats; fire, smoke, and carbon monoxide detectors; and appliances. These latter devices support households and organizations by monitoring energy usage, supply levels, and safety. The data collected from the personal electronic and IoT devices greatly expands the types of data that are collected and the diversity of the individuals from whom the data is collected. The diversity of the individuals, and the diversity of the data they provide, greatly enhances analysis tasks. The data analysis allows better understanding of gender, cultural, and geographical preferences for goods and services, information sources, and even purchasing preferences. This diverse information further enables analysis of energy efficiency and usage, incidence and spread of disease, and damage associated with naturally occurring events including storms and war. On the downside, the prevalence of these personal electronic and IoT devices exposes their users to tracking, hacking, and theft.

### SUMMARY

Data accessed from individuals, smart devices, Internet of Things (IoT) devices, web access habits, and so on can be analyzed to determine patterns, identify trends, flag anomalies, and so on. In general, the quality of analysis results is greatly enhanced when the volume of the data is large and the sources of the data are diverse. However, the broad collection of data also poses risks both to the individuals from whom the data is collected and the devices, applications, and systems with which the individuals interact. While data such as a temperature setting in a guest room of a dwelling occupied by one or more individuals might seem innocuous, knowledge that a device in that room is coupled to a microphone and camera could make that device a target of a hacking attack. Yet, data such as the temperature data is useful to tracking weather conditions, determining energy efficiency in a building, and evaluating consumer energy usage patterns, among other useful analyses. Thus, a careful balance must be struck between protecting individual identity and personal data while providing meaningful data for analysis. Such a balance can be accomplished using local differential privacy (LDP) techniques. The LDP techniques add or subtract a random noise to/from the true data to protect data privacy. The LDP techniques are applied to data stored in a local static random-access memory (SRAM). The LDP techniques are realized by failed SRAM cells at low voltages. The values of failed cells are provided by random noise generators. The random noise generator obscures the readout of failed cells, thereby greatly complicating any attempt to reverse engineer the LDP performed in a particular SRAM.

Techniques for data manipulation are disclosed. Data that requires differential privacy data manipulation is accessed for storage. The data is prepared for storage using key-based shuffling. Keys are selected by a random key index generator. The data that was shuffled is stored in a static random-access memory (SRAM). The SRAM comprises high-reliability storage cells and low-reliability storage cells. A supply voltage of the SRAM is lowered. The lowering a supply voltage produces a pre-characterized noise level in the SRAM storage cells. Cells among the low-reliability cells are flipped based on the pre-characterized noise level. The flipped cells are used to inject random noise and their values are provided by random noise generators. A read of the stored data is performed. The read occurs across both high-reliability storage cells and low-reliability storage cells. The data that was read is unshuffled, using key-based unshuffling.

A processor-implemented method for data processing is disclosed comprising: accessing data for storage, wherein the data requires differential privacy data manipulation; preparing the data for storage, wherein the preparing comprises key-based shuffling; storing the data that was shuffled in a static random-access memory (SRAM), wherein the SRAM comprises high-reliability storage cells and low-reliability storage cells; lowering a supply voltage of the SRAM, wherein the lowering a supply voltage produces a pre-characterized noise level in the SRAM storage cells; performing a read of the data that was stored; and unshuffling the data that was read, using key-based unshuffling. In embodiments, the SRAM high-reliability storage cells comprise eight-transistor (8T) storage cells and the SRAM low-reliability storage cells comprise six-transistor (6T) storage cells. In embodiments, additional high-reliability cells can be used for storing a key index. In embodiments, the keys used for the key-based shuffling and the key-based unshuffling comprise permutation patterns. In embodiments, the keys are selected for use by a random key index generator, where the random key index generator is based on one or more linear feedback shift registers. In embodiments, the index selects a pre-calculated, stored key.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for local differential privacy using static random-access memory.

FIG. 2 is a flow diagram for key usage.

FIG. 3 is a system block diagram for differential privacy SRAM.

FIG. 4A is a block diagram for SRAM cells for noise injection.

FIG. 4B is a block diagram for SRAM permutation pattern selection bits.

FIG. 5 shows a cell design for differential privacy SRAM cell.

FIG. 6 illustrates an example cell to store LSBs for noise injection.

FIG. 7A shows a bit shuffler.

FIG. 7B shows a bit unshuffler.

FIG. 8 illustrates a random bit generator.

FIG. 9 is a system diagram for local differential privacy using static random-access memory.

### DETAILED DESCRIPTION

Techniques for data manipulation based on local differential privacy using static random-access memory (SRAM) are disclosed. Data collection and analysis play key roles in areas such as engineering, science, research, business, marketing, and politics, to name only a very few. In order for the data analysis to be meaningful, the volume of the data and the diversity of the data are critical. Data diversity is particularly critical to applications such as artificial intelligence (AI) model training and marketing, where the breadth of data directly improves model response and sales predictions, respectively. Recall a disastrous attempt by a social media company to analyze the photographs that users uploaded to identify people, animals, and other image contents. When the AI tool mistakenly identified some people as animals, critical and flawed limitations in the data used for the AI model training datasets were tragically evident. The individuals who chose the datasets to use for model training did not consider whether the datasets reflected the diversity of the application users and therefore seriously offended them. Similar examples exist in examples of marketing failures, where products and services have been offered to people who could not use the products due to social, religious, or biological incompatibilities.

With the value of data being so high, effective collection of data has become highly specialized and generally proven to be quite lucrative. In attempts to gather as large and diverse datasets as possible, data is routinely collected from individuals, groups of individuals, and so on. The data can be based on individual or group behaviors and habits, devices used, lifestyle choices, preferred transportation methods, etc. The data can be collected from personal electronic devices such as computers, tablets, and smartphones; Internet of Things (IoT) devices such as smart thermostats and appliances; web surfing choices and settings; and many other sources. While provision by an individual of some of the information can be required or freely shared, other information is not. Further, an ability to trace back information to its source can breach confidentiality ethics, and in many cases, data protection laws. As a result, collected data is often anonymized and collated. Instead, differential privacy techniques can be applied to the data. These techniques are used to share information by identifying patterns, trends, groupings, and so on within data collected from one or more types of individuals. The differential privacy techniques allow the sharing of patterns and other information about the groups without revealing an individual's sensitive data.

Differential privacy techniques enable sharing of metadata, patterns, etc. that can be determined by analyzing collected data. However, the data analysis is often performed using centralized systems. Since the systems are centralized, data must be transferred from collection points such as smart and IoT devices for storage and analysis. As a result, the data is vulnerable to malicious or unauthorized analysis, theft, and so on. In disclosed techniques, differential privacy techniques are applied locally by processing data within a memory such as static random-access memory (SRAM) associated with the devices from which the data is collected. The local differential privacy (LDP) techniques are based on data “shuffling”. The shuffling is based on use of a key which can be randomly selected from a plurality of pre-calculated and stored keys. The data can be further manipulated based on a “noise injection” technique. The noise injection process can be based on applied random values in the failed SRAM cells. The failed SRAM cells can be further identified based on a pre-characterized noise level, which is produced by lowering the supply voltage to the SRAM.

Local differential privacy (LDP) using static random-access memory enables data manipulation. The data manipulation can include shuffling and unshuffling the data to provide useful reordering of data while obscuring and protecting the sensitive data. Data is obtained for storage. The data can be obtained from individuals, personal electronic devices, Internet of Things (IoT) devices, and so on. The data can require differential privacy data manipulation to prevent tracing the data back to an individual source of data. The data can be prepared for storage. The preparation of the data for storage can include key-based shuffling. The key can include a randomly generated key, a permutation pattern, and so on. The key can be selected from a plurality of keys. The data that was shuffled can be stored. The shuffled data can be stored in a memory such as a static random-access memory (SRAM). The supply voltage of the SRAM can be lowered to save power consumption. Lowering of the supply voltage can enable low-voltage operation of the SRAM. The lowering of the supply voltage of the SRAM can produce a pre-characterized noise level in the SRAM storage cells. The pre-characterized noise level can indicate which storage cells can continue to operate correctly under reduced supply voltage and which cells fail under reduced voltage. A read of the data that was stored can be performed. The read can occur across both high-reliability storage cells and low-reliability storage cells. The read across both types of storage cells can capture most significant data bits (MSBs) and least significant data bits (LSBs). The data that was read can be unshuffled. The unshuffling can be accomplished using a key. The key that was used for the data shuffling can also be the key used for the data unshuffling.

In embodiments, keys used for the key-based shuffling and the key-based unshuffling comprise permutation patterns. The permutation patterns can include subsets or sub-permutations within a larger permutation. The keys are selected for use by a random key index generator. The random key index generator can be based on software, hardware, or hybrid techniques. In embodiments, the random key index generator is based on one or more linear feedback shift registers. The keys that are randomly selected by the index are pre-calculated and stored. The pre-calculated, stored keys can be stored in the SRAM or other memory. A variety of techniques can enable use of the permutation patterns to accomplish the bit shuffling and the bit unshuffling. In embodiments, the permutation patterns are applied to data using a mux-based shuffler and/or unshuffler. Keys used for the key-based shuffling and the key-based unshuffling are stored in high-reliability storage cells. The high-reliability cells maintain key integrity. Maintaining key integrity is critical because a same key used for the key-based shuffling is used for the key-based unshuffling. The most significant bits (MSBs) of data and the least significant bits (LSBs) of data can be stored in high-reliability storage cells and low-reliability storage cells, respectively. Local differential privacy is further enabled by adding random noise among the failed SRAM low-reliability cells based on the pre-characterized noise level. The pre-characterized noise level is produced by lowering the supply voltage of the SRAM.

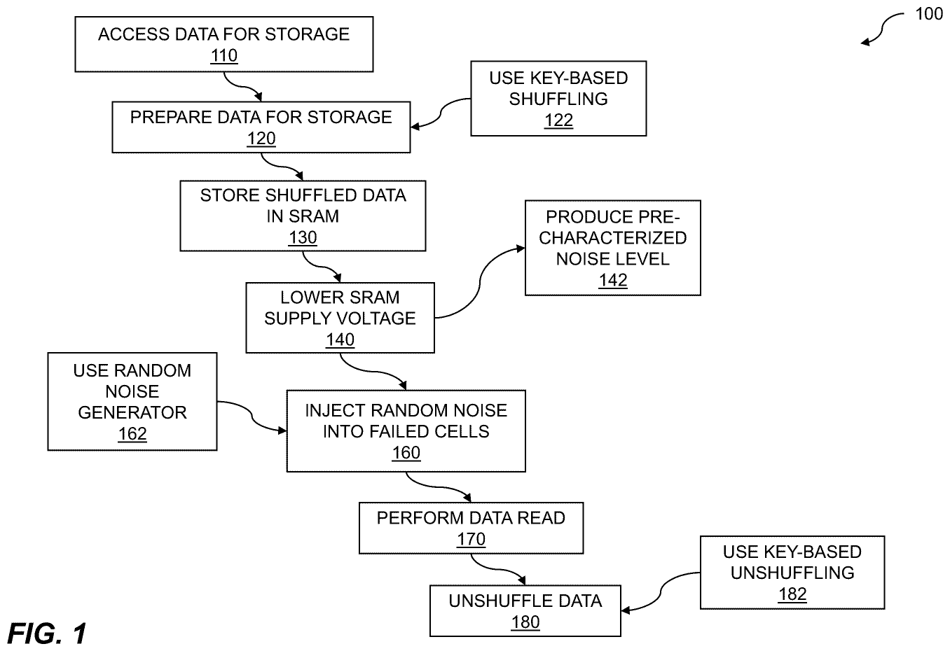

FIG. 1 is a flow diagram for local differential privacy using static random-access memory. Data can be accessed for storage. The data can include data obtained from individuals, personal electronic devices, Internet of Things (IoT) devices, and so on. The data can require differential privacy data manipulation. Differential privacy can enable accessed data to remain useful for data analysis and processing tasks while obscuring the exact value of the data. The data can be prepared for storage. Preparation of the data can be based on key-based shuffling of the data. The data that was shuffled can be stored. Components in which the data can be stored can include static random-access memory. In embodiments, the SRAM comprises high-reliability storage cells and low-reliability storage cells. The supply voltage of the SRAM can be lowered. Based on the lowering of the supply voltage, a pre-characterized noise level in the SRAM storage cells can be produced. The pre-characterized noise level can indicate which storage cells can fail under lowered supply voltage conditions. A read of the stored data is performed. The read can occur across the high-reliability storage cells and the low-reliability cells. The data that was read can be unshuffled. The unshuffling can be accomplished using key-based unshuffling. The same key that was used for the data shuffling can be used for the key-based unshuffling.

The flow 100 includes accessing 110 data for storage. The data that is accessed can be associated with a group of individuals, collections of electronic devices such as personal electronic devices, internet-connected devices such as Internet of Things (IoT) devices, and so on. The data can be accessed for analysis purposes, such as statistical analysis, trend analysis, pattern identification, and so on. The data that is accessed requires differential privacy data manipulation. The differential privacy manipulation can enable sharing of data for a group of individuals while preventing trace back of the data to a particular individual, device, etc. The differential privacy manipulation can hide or obscure personal data, protect identification data, and the like.

The flow 100 includes preparing the data for storage 120. The data preparation can be based on processing the data, encoding the data, encrypting the data, and so on. In the flow 100, the preparing comprises key-based shuffling 122. A key that can be used to shuffle the data can be obtained, calculated, and so on. The data shuffling can reorder the data bits stored in the SRAM cells such that data bits can flip according to predetermined probabilities. In embodiments, the key-based shuffling can be performed on a bit basis. The key that is used for the key-based shuffling and key-based unshuffling (discussed below) can include permutation patterns. A permutation pattern can include a subset or “sub-permutation” of a larger permutation. The keys that can be used for the data shuffling and the data unshuffling can be selected using a variety of techniques. The keys can be selected based on indexing. In embodiments, the keys can be selected for use by a random key index generator. The random key index generator can be based on software techniques, hardware techniques, hybrid software-hardware techniques, and so on. The random key index generator can generate random indices, pseudo-random indices, etc. In embodiments, the random key index generator is based on one or more linear feedback shift registers (LFSRs). The one or more LFSRs can generate a pseudo-random pattern that can generate a key index based on a seed value loaded into the LFSR. The LFSR can generate a repeatable pattern based on the seed value.

The keys can be obtained through a table lookup technique, generated, calculated, and so on. In embodiments, the index can select a pre-calculated, stored key. In a usage example, a plurality of keys based on permutation patterns can be pre-calculated and stored for data shuffling and data unshuffling tasks. The key storage can be accomplished using a lookup table, a register file, a memory, etc. In embodiments, keys used for the key-based shuffling and the key-based unshuffling can be stored in high-reliability storage cells. Discussed below, high-reliability storage cells can include more transistors than a typical six transistor (6T) SRAM cell, such as an eight transistor (8T) topology. The number of keys that can be pre-calculated can include a power of 2 such as 2, 4, 8, 16, 32, or other numbers of keys. The keys that are based on permutation patterns can be applied to the data using a variety of techniques. In embodiments, the permutation patterns can be applied to data using a mux-based shuffler and/or unshuffler. Each multiplexer or “mux” can comprise an M-input and single-output mux, where M can be equal to a number of bits associated with the accessed data. In embodiments, the data can be processed on a byte basis. The data can also be processed on a word basis, a block basis, etc.

The flow 100 includes storing the data that was shuffled 130 in a static random-access memory (SRAM). The SRAM can be based on cells that can maintain their data, such as a voltage representing a logic zero or a voltage representing a logic one, as long as a supply voltage is provided to the SRAM. The contents of the SRAM cells can be read without disturbing the cell contents. That is, the cell contents can be read without requiring a refresh (e.g., a rewrite) of the cell contents. In the flow 100, the SRAM can include high-reliability storage cells and low-reliability storage cells. The high-reliability storage cells can be more stable than the low-reliability storage cells with respect to reading the storage cells, placing the cells in a low power mode, and so on. In embodiments, the SRAM high-reliability storage cells comprise eight-transistor (8T) storage cells and the SRAM low-reliability storage cells comprise six-transistor (6T) storage cells. The keys discussed previously can be stored in memory. In embodiments, the keys can be generated outside of the SRAM. The keys can be stored in memory that can be colocated with the SRAM, coupled to the SRAM, and the like.

Recall that data can be stored in the SRAM and processed in the SRAM on a byte basis. The storage of a byte, for example, can be accomplished using a combination of high-reliability storage cells and low-reliability storage cells.

The flow 100 includes lowering the supply voltage 140 of the SRAM. The lowering the supply voltage of the SRAM can include placing the SRAM into a low power mode. The low power mode can include an operating mode that enables the SRAM to consume less power. The low power mode can include a sleep mode. Note that lowering the supply voltage of the SRAM can cause some of the storage cells to fail. Storage cell failure can include an inability to write and read data, a corruption or loss of the data stored in a cell, and so on. While a modern SRAM typically uses a single supply voltage, often designated as Vdd, an SRAM could be implemented using a plurality of supply voltages, one or more of which, when lowered, will cause some cells to fail. In the flow 100, the lowering the supply voltage produces a pre-characterized noise level 142 in the SRAM storage cells. The noise level corresponds to how many (and which) cells tend to fail at a certain voltage level. Lowering the supply voltage will increase the noise level. The lowering the supply voltage can be performed offline or ahead of actual device usage to provide the pre-characterization of the low-reliability cells.

The flow 100 includes performing a read of the data 170 that was stored, and random values 160 can be injected among the SRAM failed cells based on the pre-characterized noise level. The injecting random values can be performed using a random noise generator 162. The read occurs across both high-reliability storage cells and low-reliability storage cells. The reading can be accomplished by providing an address to contents of the SRAM. The address can be used to activate word lines associated with storage cells at the provided address. The reading can include precharging bit lines associated with the high-reliability storage cells and with the low-reliability storage cells. The precharging bit lines can speed access to the contents of the storage cells and can minimize disturbance of the contents of the storage cells. The storage cells can be accessed by activating word lines associated with the address provided for the read operation. The bit lines of the same column are coupled to a sense amplifier such as a differential sense amplifier. The sense amplifier determines which of the contents of the activated cell represents a logic one or a logic zero and generates a corresponding one or zero. In the flow 100, the sense amplifier output of each column and a one-bit random noise generator are two inputs of a failure noise mux. The failure noise muxes are controlled by the pre-characterized noise level to enable the noise injection process. Based on the pre-characterized noise level (failed cell positions), the values generated by the random noise generators are selected for the failed cells as the final read output. The random noise generator can be based on software random noise techniques, hardware random noise techniques, hybrid software-hardware techniques, and so on.

The flow 100 includes unshuffling 180 the data that was read. The unshuffling can be performed on a byte basis, a word basis, a block basis, and so on. The unshuffling the data can reverse the shuffling of the data. In the flow 100, the unshuffling is accomplished using key-based unshuffling 182. The key used for the unshuffling can be obtained using an index into the pre-calculated and stored keys. In embodiments, a same key used for the key-based shuffling is used for the key-based unshuffling. In embodiments, the same key used for the key-based shuffling that is used for the key-based unshuffling is applied to a block of data. The block of data can be processed as a whole, as a collection of bytes or words, and the like. In embodiments, the key-based unshuffling can be performed during the reading operation of the SRAM. Thus, the contents of the SRAM can be processed without the data being read out of the SRAM to external storage. In further embodiments, the unshuffling can occur before presentation of the data to SRAM data terminals.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

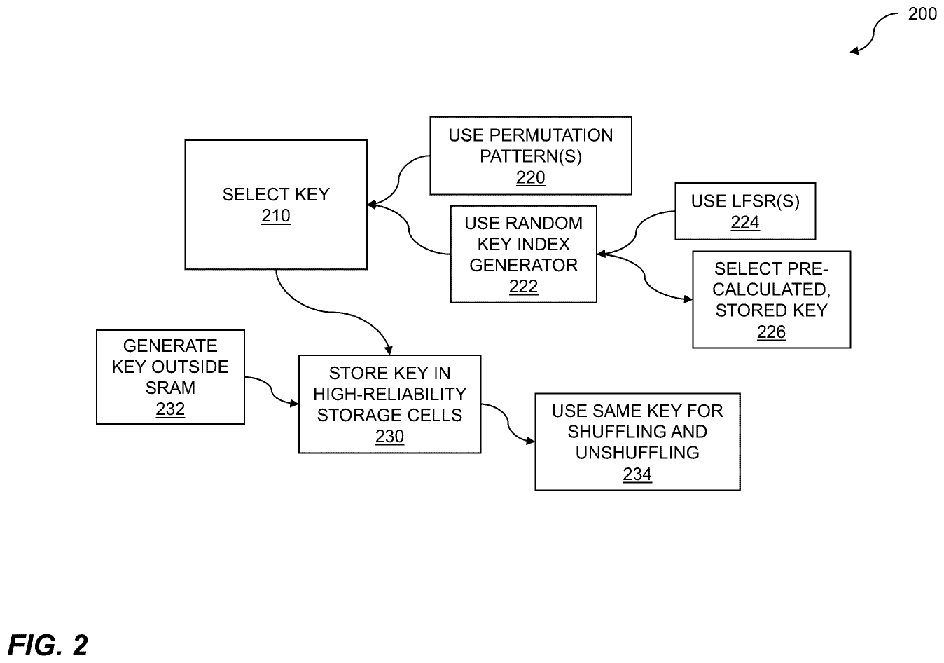

FIG. 2 is a flow diagram for key usage. A key such as a random index key can be selected using a random key index generator. The random key index can be used to select a key that can be used for shuffling the data and for unshuffling the data. The shuffling and the unshuffling data can be used to alter the cell positions in which data bits are stored. The shuffling and the unshuffling the data guarantee data bits are randomized following predetermined probabilities. The usage of the random index key enables local differential privacy using static random-access memory. Data is accessed for storage, wherein the data requires differential privacy data manipulation. The data is prepared for storage, wherein the preparing comprises key-based shuffling. The data that was shuffled is stored in a static random-access memory (SRAM), wherein the SRAM comprises high-reliability storage cells and low-reliability storage cells. The supply voltage of the SRAM is lowered, wherein the lowering the supply voltage produces a pre-characterized noise level in the SRAM storage cells. A read of the data that was stored is performed, wherein the random noise is injected to the failed storage cells. The data that was read is unshuffled, using key-based unshuffling.

The flow 200 includes selecting keys 210. The keys are selected for preparing data for storage by shuffling the data, and for unshuffling data read from storage. The keys can include a hash, a code, a pattern, and so on. The key used for shuffling data can include the same key used for unshuffling the data. In the flow 200, keys used for the key-based shuffling and the key-based unshuffling comprise permutation patterns 220. A permutation pattern can include a subset or “sub-permutation” of a longer permutation. The key selected for data shuffling and data unshuffling can be based on a random selection, a pseudo-random selection, and so on. In the flow 200, the keys are selected for use by a random key index generator 222. The random key index generator can be based on a hardware generator, a software generator, a combination of hardware and software generators, and the like.

In the flow 200, the random key index generator is based on one or more linear feedback shift registers (LFSRs) 224. The one or more LFSRs can compute polynomials that appear to produce random values. The random values generated by the one or more LFSRs can be used as indices into a collection of keys that can be used for the data shuffling and the data unshuffling. In the flow 200, the index selects a pre-calculated, stored key 226. The pre-calculated key can include a key among a plurality of pre-calculated keys. The pre-calculated keys can be calculated using hardware techniques, software techniques, a combination of hardware-based techniques and software-based techniques, and the like. In the flow 200, keys used for the key-based shuffling and the key-based unshuffling are stored in high-reliability storage cells 230. The keys can be stored in high-reliability storage cells in order to maintain key integrity. In the flow 200, the keys are generated outside 232 of the SRAM. Discussed previously, the keys can be generated using key generation hardware, software, a combination of hardware and software, etc. The keys can be stored in high-reliability storage cells that are colocated with the SRAM, storage cells coupled to the SRAM, and so on. In the flow 200, the same key that is used for the key-based unshuffling 234 is applied to a block of data. Since the same key is used for the data shuffling and the data unshuffling, maintaining key integrity is critical. The maintaining the key integrity can be accomplished using high-reliability storage cells for storing keys.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

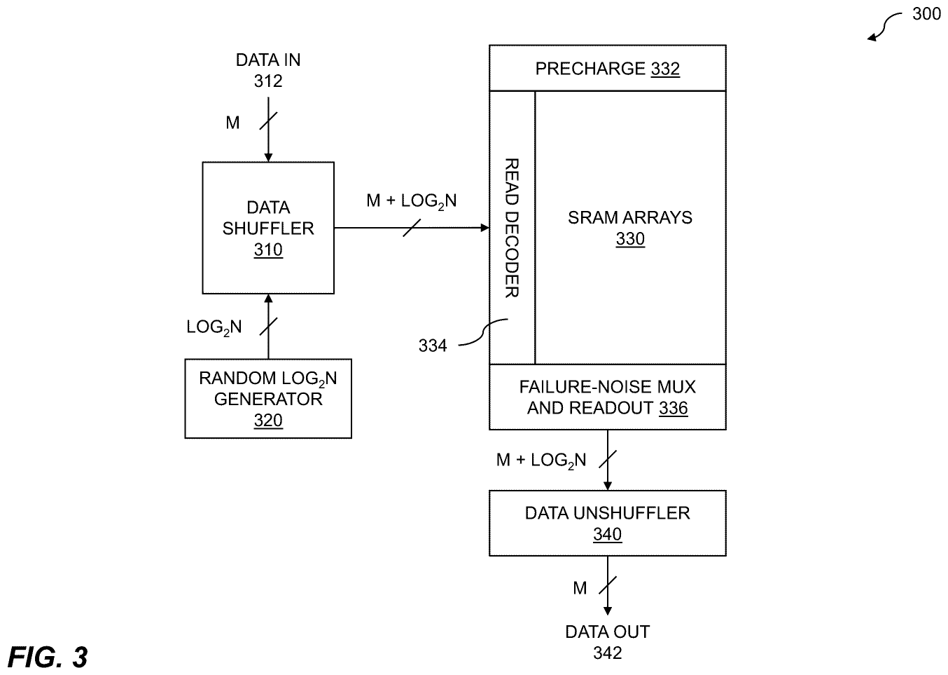

FIG. 3 is a system block diagram for differential privacy SRAM 300. Discussed previously and throughout, differential privacy (DP) is a technique that can be used to share information collected from a plurality of sources. The sources can include individuals, personal electronic devices, Internet of Things (IoT) devices, and so on. DP techniques can enable private analysis of the information to determine trends, identify anomalies, and the like. The DP techniques further enable withholding or hiding information that can be associated with individuals, individual devices, etc. Differential privacy can be accomplished locally, in contrast to accomplishing DP using a centralized server. The prepared data can then be stored locally in a static random-access memory (SRAM) such as a differential privacy SRAM. The DP SRAM enables local differential privacy using static random-access memory. Data is accessed for storage, wherein the data requires differential privacy data manipulation. The data is prepared for storage, wherein the preparing comprises key-based shuffling. The data that was shuffled is stored in a static random-access memory (SRAM), wherein the SRAM comprises high-reliability storage cells and low-reliability storage cells. The supply voltage of the SRAM is lowered, wherein the lowering the supply voltage produces a pre-characterized noise level in the SRAM storage cells. A read of the data that was stored is performed, wherein the noise injection occurs on those failed cells. The data that was read is unshuffled, using key-based unshuffling.

A system block diagram for a differential privacy (DP) static random-access memory (SRAM) includes a data shuffler 310. The data shuffler can shuffle data to enable differential privacy of the data for the first step. Input data such as data in 312 is provided to the data shuffler. The input data can include one or more bits. In embodiments, the input data comprises M bits. The data shuffling can be based on a code, a pattern, and so on. Described previously, the shuffling can be based on a key. In embodiments, the same key used for the key-based shuffling is used for the key-based unshuffling (described below). In embodiments, keys used for the key-based shuffling and the key-based unshuffling comprise permutation patterns. The permutation patterns can be pre-calculated and stored. The key can include a randomly selected key, where the selected key can include a key within a plurality of keys. In embodiments, the keys that are used for the shuffling and for unshuffling (described below) are selected for use by a random key index generator 320. The random key index generator can be based on a random number generator, a pseudorandom number generator, and so on. In embodiments, the random key index generator can be based on one or more linear feedback shift registers. The random key index generator can generate one or more index bits. In embodiments, the random key index generator can generate log₂N bits, where N is the number of random key patterns that have been generated and stored.

The data shuffler shuffles the input data based on the permutation pattern selected by the random key index generator. The shuffled data and the random key index are sent to one or more static random-access memory arrays 330. The shuffled data and the random key index can include M+log₂N bits. The SRAM can include high-reliability storage cells and low-reliability storage cells. In embodiments, the SRAM high-reliability storage cells can include eight-transistor (8T) storage cells and the SRAM low-reliability storage cells comprise six-transistor (6T) storage cells. The various bits of the shuffled data and the random key index can be stored in a mix of high-reliability storage cells and low-reliability storage cells. In embodiments, the random key index keys used for the key-based shuffling and the key-based unshuffling are stored in high-reliability storage cells. The shuffled data can be stored in a mix of high-reliability cells and low-reliability cells.

Discussed throughout, bit lines can be associated with the SRAM cells. The bit lines can include true bit lines and complemented bit lines. In order to enhance operation of the SRAM cells, the bit lines can be precharged. The precharging the bit lines can be accomplished using a precharge component 332. The precharge component can comprise a plurality of pullup devices such as PMOS devices. A read decoder 334 can be associated with the SRAM arrays. The read decoder can decode addresses of storage cells within the SRAM arrays. The SRAM can further include a failure-noise multiplexer (MUX) and “readout” component 336. Discussed below, the failure-noise mux can be used to enable noise injection among the failed low-reliability cells.

The “readout” component can comprise one or more sense amplifiers. The sense amplifiers can be used to read the contents of the high-reliability storage cells and the low-reliability storage cells. The sense amplifiers can further be used to read the contents of the random key index from associated high-reliability storage cells. The failure-noise mux and readout component can present a number of lines to a data unshuffler 340. The number of lines can include a number of data lines and a number of random key index lines. In embodiments, the number of lines can include M+log₂N lines. The data unshuffler can unshuffle the loaded data in the memory based on the key pointed to by the random key index. In embodiments, the key-based unshuffling can be performed on a bit basis. The unshuffling can be performed by a variety of components. In embodiments, the key-based unshuffling can be performed within the SRAM. Performing the unshuffling within the SRAM can recover the initially shuffled bits back to its original order. The data that is presented as data out 342 can include a plurality of bits. In embodiments, data out can include M bits, where M corresponds to the number of bits in the input data, data in 312.

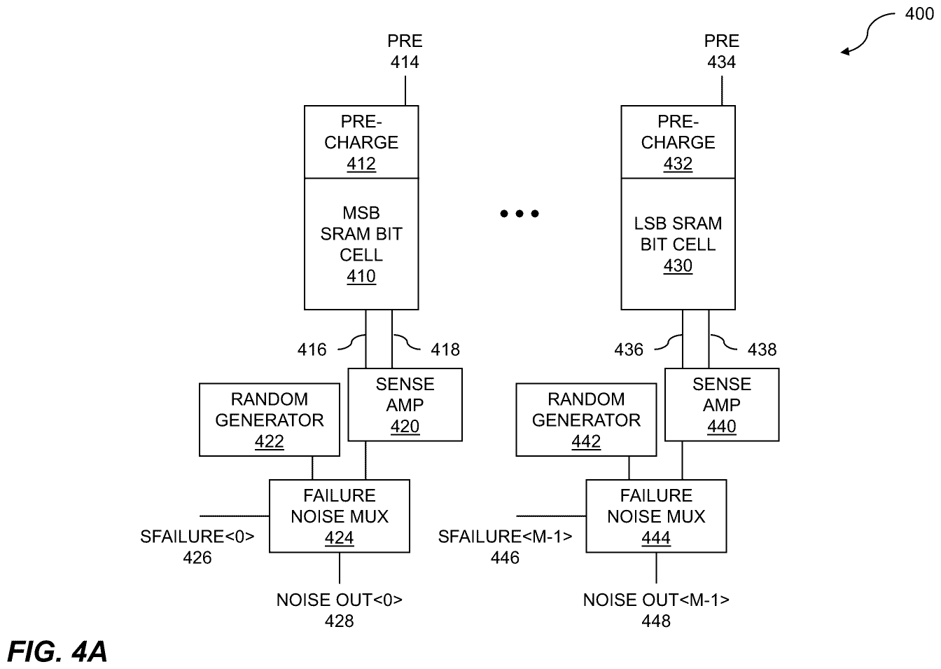

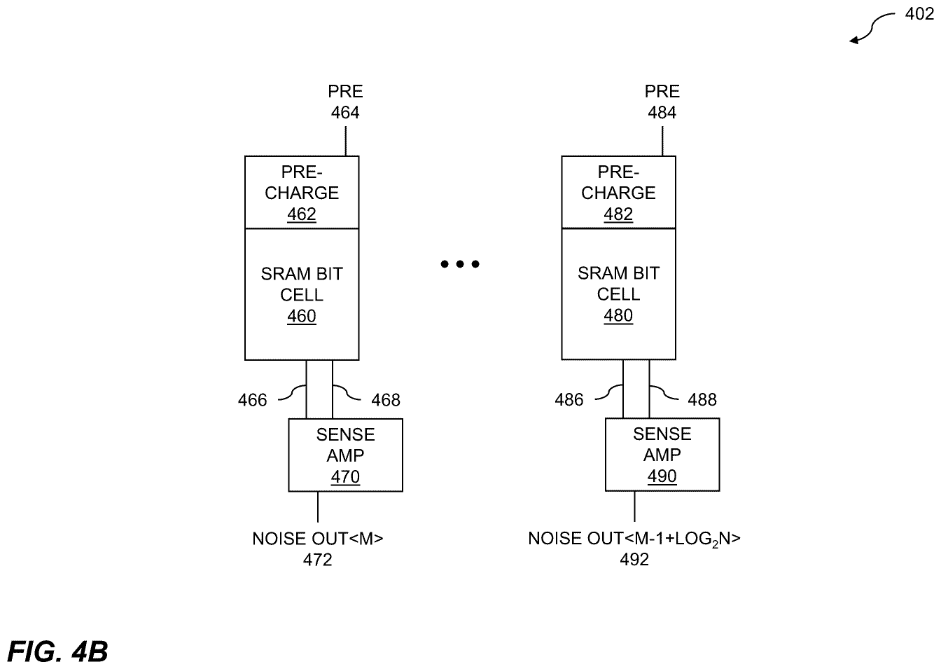

FIG. 4A is a block diagram for SRAM cells for noise injection. Discussed throughout, lowering a supply voltage of a static random-access memory (SRAM) can be used to inject random noise into the memory. The injecting of random noise can be desirable when the data contained in the memory is useful for anonymized data. The anonymized data is useful for enabling analysis of the data by authorized parties such as authorized curators of the data. The noise-injected data provides valuable information while protecting the true values of the data. The noise-injected data can prevent unauthorized parties from obtaining sensitive information. The noise injection enables local differential privacy using static random-access memory. Data is accessed for storage, wherein the data requires differential privacy data manipulation. The data is prepared for storage, wherein the preparing comprises key-based shuffling. The data that was shuffled is stored in a static random-access memory (SRAM), wherein the SRAM comprises high-reliability storage cells and low-reliability storage cells. The supply voltage of the SRAM is lowered, wherein the lowering the supply voltage produces a pre-characterized noise level in the SRAM storage cells. A read is performed on the data that was stored, wherein the read occurs across both high-reliability storage cells and low-reliability storage cells. The noise injection is done during the reading process. The data that was read is unshuffled, using key-based unshuffling.

SRAM cells for noise injection are shown 400. The SRAM cells can include a most significant bit (MSB) such as SRAM bit cell 410, a number of intermediate bits, a least significant bit (LSB) such as SRAM cell 430, and so on. The number of SRAM cells that can be included can be based on the amount of data that can be processed. In embodiments, the data can be processed on a byte basis. In other embodiments, the data can be processed on a word or similar basis. Discussed below, additional SRAM cells, such as SRAM cells for storing a pattern which can be used to select a key for shuffling and unshuffling data, can be included. In embodiments, each pattern has two bits and can be stored in high-reliability storage cells. Each SRAM cell can include a precharge component such as precharge 412, which can be controlled by a precharge signal 414, and precharge 432, which can be controlled by a precharge signal 434. The precharge components can include pullup devices. The precharge components can be used to precharge one or more bit lines, such as bit line BL 416 and bit line bar (complement) BLB 418 associated with SRAM cell 410, and BL 436 and BLB 438 associated with SRAM cell 430. Precharging of the one or more bit lines can enable reading data from the cells.

The one or more bit lines associated with each SRAM cell are coupled to a sense amplifier such as sense amplifier 420 and sense amplifier 440. The sense amplifiers can be used to read the contents of the SRAM cells with minimal disturbance to the contents. A random noise generator can be associated with each column of SRAM cells, such as random noise generator 422 and random noise generator 442. The random noise generators can produce random values which will be used as random noise and applied to those failed cells. Each sense amplifier output and each random noise generator output is coupled to a multiplexer (MUX) such as a failure noise mux. The failure noise muxes can include failure noise MUX 424 and failure noise MUX 444. Each failure noise mux is controlled by a signal associated with a pre-characterized noise level in the SRAM storage cells. The control signals can include control signals sfailure<0> 426 and sfailure<m−1> 446. Recall that the pre-characterized noise level is produced by lowering the supply voltage of the SRAM to determine which cells can fail at reduced voltage. The pre-characterized noise can indicate a memory failure. The output of the failure noise muxes produces noise out signals such as noise out 428 and noise out 448. The noise output can include either the sense amp output when no failure is indicated, or the random noise generator output when a failure is indicated.

FIG. 4B is a block diagram for SRAM permutation pattern selection bits. Discussed above, the static RAM (SRAM) is used for storing the data that was shuffled. The data that was stored was shuffled based on a permutation pattern from a plurality of permutation patterns. The permutation patterns can be precalculated and stored. The permutation pattern used for the data shuffling can be selected at random. In embodiments, the keys can be selected for use by a random key index generator. The random key index generator can include a random number generator, a pseudorandom number generator, and so on. In embodiments, the random key index generator can be based on one or more linear feedback shift registers. In order to keep track of which key was randomly selected for the shuffling so that the same key can be used for unshuffling, additional log₂N columns can be coupled to the SRAM for storing the key index, where N is the number of permutation patterns.

The additional SRAM columns can be colocated with the SRAM data columns coupled to the SRAM, and so on. Since the integrity of the randomly selected key index is critical to successful unshuffling of the shuffled data in the SRAM, high-reliability storage cells such as 8T cells can be used to store the index bits. Further, no noise need be introduced into the stored index bits. A block diagram for SRAM permutation pattern selection bits is shown 402. The portion of the SRAM that stores the permutation pattern bits can include SRAM cells such as SRAM cell 460 and SRAM cell 480. Each column of cells can include a precharge component such as precharge 462 and precharge 482. The precharge components can be used to present bitlines prior to reading operations and writing operations. Each precharge component can be controlled by a precharge signal such as precharge 464 and precharge 484. One or more bit lines such as bit line pairs can be associated with each SRAM bit cell. The bitlines can include a true bit line such as bit lines 466 and 486. The bit lines can further include complemented bit lines or bit lines “barred” (BLB) such as bit line bar (BLB) 468 and bit line bar (BLB) 488. The bit line pairs from SRAM bit cells can be coupled to sense amplifiers such as sense amplifier 470 and sense amplifier 490. The sense amplifiers can include differential sense amplifiers. The sense amplifiers respond to signals on their associated bit and bit bar lines to determine a signal output from each of the sense amplifiers. The signal output can include a voltage that represents a logic one value or a logic zero value. The sense amp output can be selected as noise out<m> 472, noise out<m−1+log₂N> 492, and so on, when no failure is indicated; otherwise, the random noise generator output will be selected as noise out.

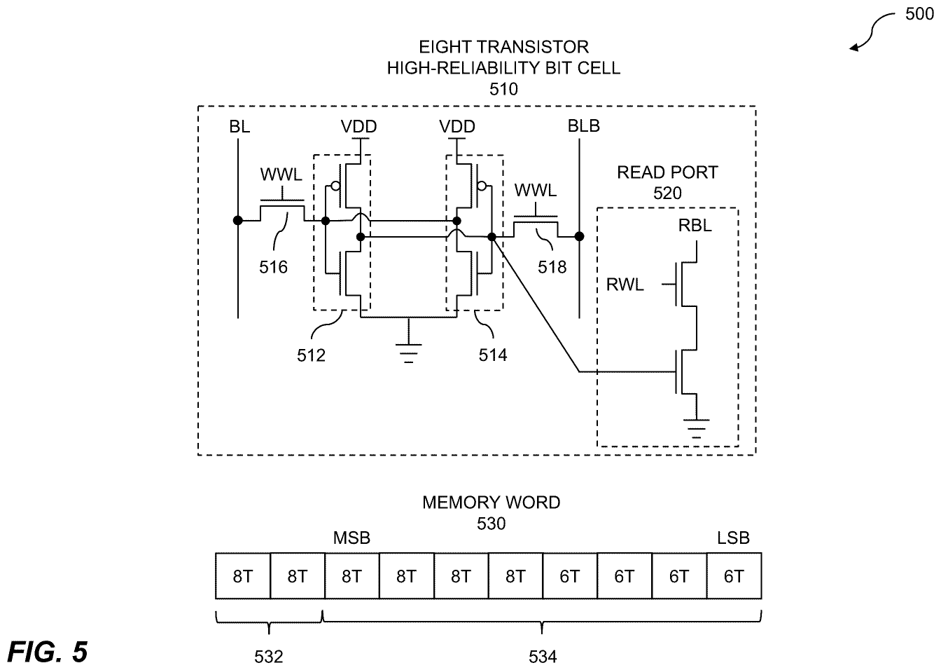

FIG. 5 shows a cell design for a differential privacy SRAM cell. Discussed above and throughout, data protection is particularly important when collected data can be associated with an individual, a particular location, and so on. Examples of data for which protection can be desirable or indeed mandated can include individual data such as personal device usage, environmental data collected by sensors, and so on. The collected data can further include data obtained from Internet of Things (IoT) devices such as smart thermostats, appliances, and the like. One technique that can be used to protect data privacy can be differential privacy. The objective of differential privacy (DP) is to enable data privacy without sacrificing general statistics associated with the data, nor introducing excessive computation overhead while enabling the privacy. Local differential privacy (LDP) advances the DP technique by perturbing data locally, such as within a static random-access memory (SRAM), rather than by a centralized server.

The LDP enables local differential privacy using static random-access memory. Data is accessed for storage, wherein the data requires differential privacy data manipulation. The data is prepared for storage, wherein the preparing comprises key-based shuffling. The data that was shuffled is stored in a static random-access memory (SRAM), wherein the SRAM comprises high-reliability storage cells and low-reliability storage cells. The supply voltage of the SRAM is lowered, wherein the lowering the supply voltage produces a pre-characterized noise level in the SRAM storage cells. A read of the data that was stored is performed, wherein the read occurs across both high-reliability storage cells and low-reliability storage cells. The data that was read is unshuffled, using key-based unshuffling. In embodiments, a same key used for the key-based shuffling is used for the key-based unshuffling.

An example cell for differential privacy is shown 500. The cell can be based on an eight-transistor (8T) high-reliability cell 510. The 8T cell can store a bit in an SRAM. The 8T cell is based on cross-coupled inverters. The inverters that are cross-coupled can include CMOS inverters such as inverter 512 and inverter 514. The cross-coupling of the inverters is accomplished by coupling the output of inverter 512 to the input of inverter 514, and the output of inverter 514 to the input of inverter 512. Once a bit is loaded into the cross-coupled inverters, the bit can remain static while sufficient power is provided to the inverters. The 8T cell further includes pass transistors or access transistors 516 and 518. The pass transistors are controlled by a word write line WWL. The pass transistors couple a bit line BL to the input of inverter 512, and a bit line bar (e.g., inverted) BLB to the input of inverter 514. The pass transistors and bit lines are further used for reading data from the cell. In embodiments, the 8T includes a read port 520. The read improves reading the contents of the cell by providing a buffer for the read operation. The buffer reduces possible disturbances and potential flipping of the cell during the read operation. The read operation can be controlled by two read lines, including a read write line and a read bit line.

Discussed previously and throughout, data can be prepared for storage by processing the data using key-based shuffling. In embodiments, the data can be processed on a byte basis. The processed data can be stored in the SRAM. Recall that the data is stored in high-reliability storage cells and low-reliability storage cells. In addition to the data, two additional bits can be stored. In embodiments, the additional two bits include a two-bit pattern selection. The two bits associated with the pattern selection can include the key index used to select a key for the data shuffling. The two-bit pattern selection selects the same key used for the data shuffling as for the data unshuffling. An example memory word 530 is shown. The memory word can include the two-bit pattern selection 532 and the data byte 534. The two-bit pattern can be stored in high-reliability 8T cells. High-reliability 8T cells can be used to store most significant bits (MSBs). In embodiments, the MSB storage cells can store the highest-order three bits of a byte. Low-reliability 6T cells can be used to store least significant bits (LSBs). In embodiments, the high-reliability 8T cells can store four MSBs of a byte, and the low-reliability 6T cells can store the four LSBs of a byte.

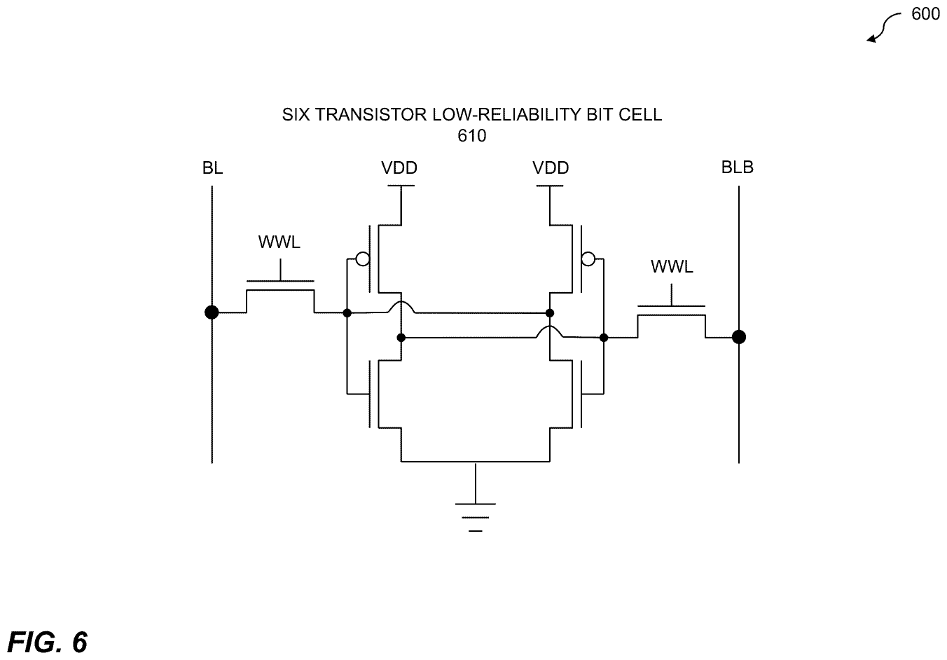

FIG. 6 illustrates an example cell to store LSBs for noise injection. An example cell for differential privacy is shown 600. Recall that data that can be accessed for storage can be prepared using key-based shuffling. The prepared data can be stored in a static random-access memory (SRAM), where the SRAM includes high-reliability storage cells and low-reliability storage cells. The latter low-reliability cells can comprise six-transistor (6T) storage cells 610. A 6T cell can be less robust with respect to supply voltage than an 8T cell. Discussed previously, in embodiments, the low-reliability storage cells can store LSBs. The LSB cells can be associated with an amount of processed data such as a byte, a word, and so on. In embodiments, the data can be processed on a byte basis. The LSBs of a processed byte can be stored in the low-reliability 6T storage cells. In embodiments, the low-reliability 6T storage cells can store four LSBs of a byte. The 6T low-reliability cells can be fabricated in a variety of semiconductor technologies such as CMOS technologies. The CMOS technologies can be based on a range of feature sizes. A feature size associated with a CMOS technology can include a 45 nm feature size.

As for the eight-transistor (8T) high-reliability storage cells discussed previously, the six-transistor low-reliability storage cells can be based on cross-coupled inverters and pass or “access” transistors. The 6T cells can be controlled by write lines (WL) and can perturb a pair of bit lines. The bit lines can include a true bit line (BL) and a complemented or “barred” bit line (BLB). The bit lines of a 6T cell can be coupled to a differential sense amplifier (not shown) that can resolve the value of the contents of the 6T cell as a logic one value or a logic zero value. The transistors associated with the cross-coupled inverters and the transistors can be sized to reduce read access speed, data integrity, and so on. In embodiments, the PMOS pullup (PU) devices of the cross-coupled inverters can include a shape factor (e.g., W/L) of 100 nm/50 nm. The NMOS pulldown (PD) devices associated with the inverters can include a shape factor of 200 nm/50 nm. The pass transistors that accomplish access to the 6T storage cells can include a shape factor of 150 nm/50 nm.

Recall that the supply voltage of the SRAM can be lowered. The lowering the SRAM supply voltage can produce a pre-characterized noise level in the SRAM storage cells. The pre-characterized noise level can be used for flipping cells among the SRAM low-reliability cells. Lowering the supply voltage of the SRAM can enable a low power operation of the SRAM. Further, each memory cell such as a 6T low-reliability cell has a probability f to fail. Cell failure can cause flipping the contents of the cell, where the flipping can include a zero-to-one transition, or a one-to-zero transition. Conversely, the probability that a cell does not flip can have a probability 1-f. Based on these probabilities, the memory array can be randomized to independently apply a technique such as a randomized response (RR) technique. In embodiments, the flipping cells can be further controlled by a random noise generator. The random noise generator can generate one or more bits that can be used to randomize data of the failed low-reliability SRAM cells. The randomizing the memory array can further be accomplished by sizing one or more memory cells or changing the cell structures. Changing the size of memory cells or modifying cell structures can cause a memory cell to be more or less likely to fail under application of a lower SRAM voltage.

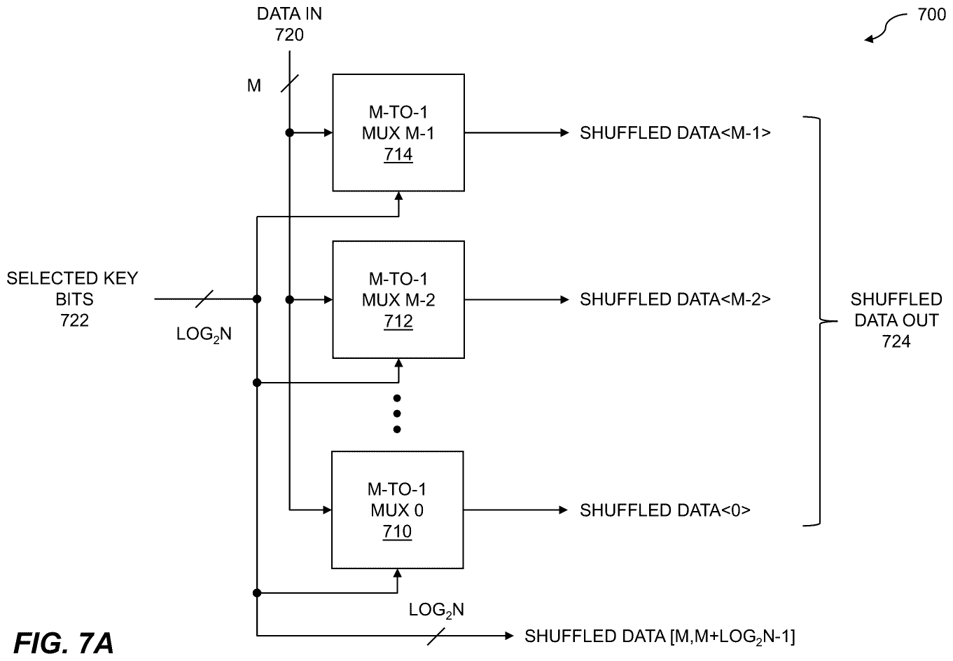

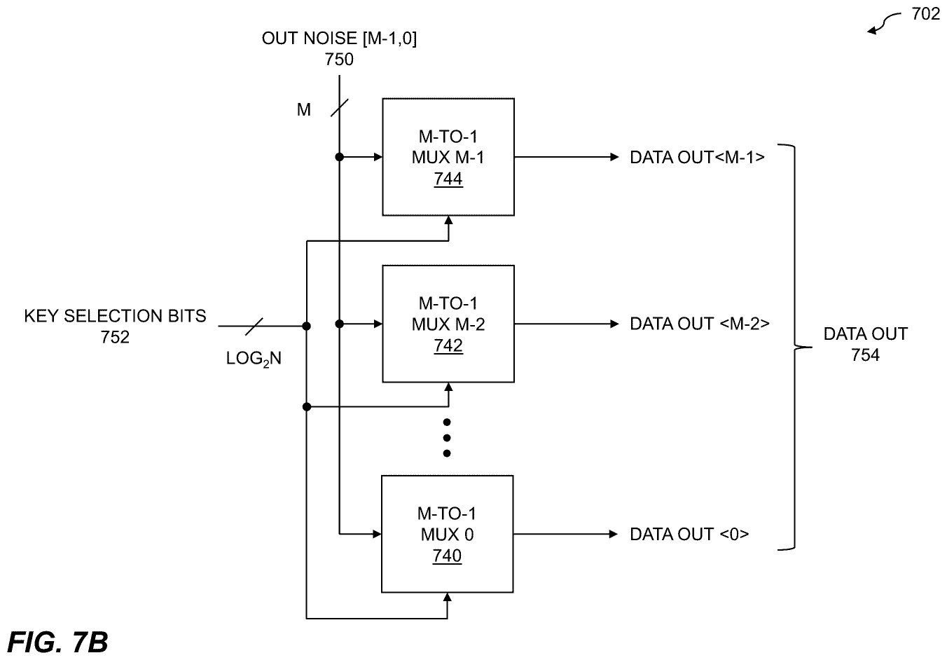

FIG. 7A shows a bit shuffler 700. The bit shuffler can be used to prepare data for storage in a storage device such as a static random-access memory (SRAM). The bit shuffler shuffles the data based on a key selected from a plurality of keys. In embodiments, keys used for the key-based shuffling (and the key-based unshuffling discussed below) comprise permutation patterns. The keys can include pre-calculated, stored keys, where the keys can be stored in an SRAM, a register file, cache storage, etc. A key can be selected by using an index into the plurality of pre-calculated, stored keys. In embodiments, the keys are selected for use by a random key index generator. The random key index generator can be based on a random number generator, a pseudo-random number generator, and so on. In embodiments, the random key index generator can be based on one or more linear feedback shift registers (LFSRs). The one or more LFSRs can generate repeatable, pseudorandom numbers for the key index. The bit shuffler enables local differential privacy using static random-access memory. Data is accessed for storage, wherein the data requires differential privacy data manipulation. The data is prepared for storage, wherein the preparing comprises key-based shuffling. The data that was shuffled is stored in a static random-access memory (SRAM), wherein the SRAM comprises high-reliability storage cells and low-reliability storage cells. The supply voltage of the SRAM is lowered, wherein the lowering the supply voltage produces a pre-characterized noise level in the SRAM storage cells. A read of the data that was stored is performed, wherein the random noise is injected using the failed low-reliability storage cells. The data that was read is unshuffled, using key-based unshuffling.

A bit shuffler 700 can be used to reorder data based on a selected key. The bit shuffler can comprise M M-to-1 multiplexers (MUX) such as M-to-1 MUX 0 710, M-to-1 MUX M−2 712, and M-to-1 MUX M−1 714. The number of M-to-1 muxes associated with the bit shuffler can include 2, 4, 8, or 16 muxes, and so on. Data such as data in 720 can be accessed. The data can be prepared for storage by shuffling the data using the M-to-1 muxes. The muxes can shuffle data based on a selected key. The selected key can include a permutation pattern that was pre-calculated and stored with other pre-calculated keys. The key can comprise a number of bits. In the example, the selected key bits 722 can include log₂N bits. The selected bits can be coupled to the selector inputs of each of the M-to-1 multiplexers to accomplish the data shuffling. The shuffled data, data out 724, is provided at the outputs of the muxes. In addition to the shuffled data, the selected key bits 722 are also provided. The provided selected key bits are used by an unshuffler (described below) to later restore the data to its unshuffled order.

FIG. 7B shows a bit unshuffler. The bit unshuffler 702 can accomplish key-based unshuffling. The unshuffler can be used to reverse data shuffling that was performed while preparing data for storage. The unshuffler can unshuffle data that was obtained by performing a read of stored data within an SRAM. The unshuffling is based on a key, where the key that is used to unshuffle the read data is the same key that was used for shuffling the data when the data was prepared for storage. The unshuffling the data enables local differential privacy using static random-access memory. Described previously, the shuffling and the unshuffling can be based on permutation patterns. The permutation patterns can be stored in a random key index, and a random key can be selected using a key index generator. In embodiments, the permutation patterns can be applied to data using a mux-based unshuffler. The mux-based unshuffler can comprise a quantity M M-to-1 multiplexers (MUX). In the figure, the mux-based unshuffler can include one or more M-to-1 muxes, such as M-to-1 MUX 0 740, M-to-1 MUX M−2 742, and M-to-1 MUX M−1 744. The value M can include 2, 4, 8, 16, and so on. The data provided to the M M-to-1 muxes is denoted by “out noise” 750. Recall that in embodiments, the data can be processed on a byte basis, where M can be equal to 8. In the example, out noise<m−1> denotes the most significant bit (MSB), and out noise<0> denotes the least significant bit (LSB). The control signal to the muxes comprises key selection bits 752, where the key selection bits can include out noise [M, M+log 2N−1]. Recall that N can be the number of permutation patterns that are stored. The key selection bits 752 can be used to revert the memory output data (e.g., the read data) to the original bit orders. The original bit orders can be provided at data out [M−1, 0] 754.

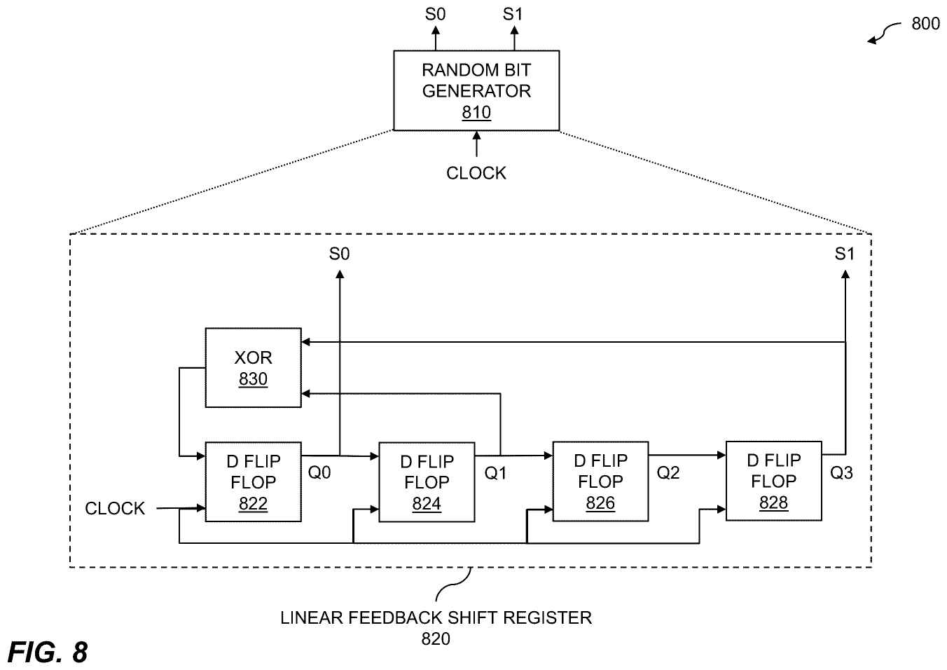

FIG. 8 illustrates a random bit generator 800. Discussed previously and throughout, keys that can be selected for key-based shuffling and key-based unshuffling of data can be stored in storage cells such as high-reliability storage cells. The high-reliability storage cells can be associated with a memory such as a static random-access memory (SRAM). The keys, which can be generated outside of an SRAM, can be based on patterns. In embodiments, keys used for the key-based shuffling and the key-based unshuffling can include permutation patterns. The keys such as permutation patterns used for the shuffling and the unshuffling can be selected using a variety of techniques. The techniques used for key selection can include random number generation techniques, pseudo-random number generation techniques, and so on. The pseudo-random number generation techniques can be particularly useful because the pattern of generated “random numbers” appears random and is repeatable. The generation techniques can include random bit generation techniques. The random bit generation techniques enable local differential privacy using static random-access memory. Data for storage is accessed, wherein the data requires differential privacy data manipulation. The data is prepared for storage, wherein the preparing comprises key-based shuffling. The data that was shuffled is stored in a static random-access memory (SRAM), wherein the SRAM comprises high-reliability storage cells and low-reliability storage cells. The supply voltage of the SRAM is lowered, wherein the lowering the supply voltage produces a pre-characterized noise level in the SRAM storage cells. A read of the data that was stored is performed, wherein the read occurs across both high-reliability storage cells and low-reliability storage cells. The data that was read is unshuffled, using key-based unshuffling.

A random bit generator is shown 810. The random bit generator can generate one or more random bits such as bits S0 and S1. The generated bits can be used as a random key index to select a key for preparing data for storage by shuffling the data, and for unshuffling data read from an SRAM in which the shuffled data was stored. The random bit generator can include a clock signal, where the clock signal can be used to operate the random bit generator. The random bit generator can operate in “free run” mode, when the clock signal is enabled, and so on. The random bit generator can be based on a variety of circuits that can generate the random key index. In embodiments, the random key index generator can be based on one or more linear feedback shift registers (LFSRs). The linear-feedback shift register can be used to generate a repeatable, pseudo-random pattern at a low implementation cost. A LFSR can generate “random” numbers by being provided with a seed number and one or more clock signals. That is, the numbers generated by the one or more LFSRs are not strictly random. The numbers can appear to switch randomly within a range of numbers controlled by the number of bits in a LFSR. Further, the pattern of random numbers is repeatable. If the same seed and the same number of clock signals are provided to the LFSR, then the “random” numbers that are generated by the LFSR will be substantially similar. The random bit generator can also be based TRNGs (True Random Number Generators) to generate strictly random numbers at a higher implementation cost.

An example linear-feedback shift register is shown 820. The example LFSR can include a clock signal (clock) that can be used to operate the LFSR. The LFSR can include a plurality of data flip-flops (D flip-flop) such as D flip-flop 822, D flip-flop 824, D flip-flop 826, and D flip-flop 828. While four D flip-flops are shown for this example LFSR, other numbers of D flip-flops can be included in the LFSR. The LFSR can include one or more exclusive OR (XOR) gates such as XOR 830. The XOR can be used to implement a randomizing expression. The randomizing expression can be based on one or more taps on outputs of D flip-flops associated with the LFSR, such as taps Q1 and Q3. The randomizing expression can include f(x)=x⁴+x²+1. One or more generated random bits can be used as the random key index, as described above. In the example shown, selection bit S0 can be tapped off of the output Q0 of D flip-flop 822, and selection bit S1 can be tapped off of the output Q3 of D flip-flop 828.

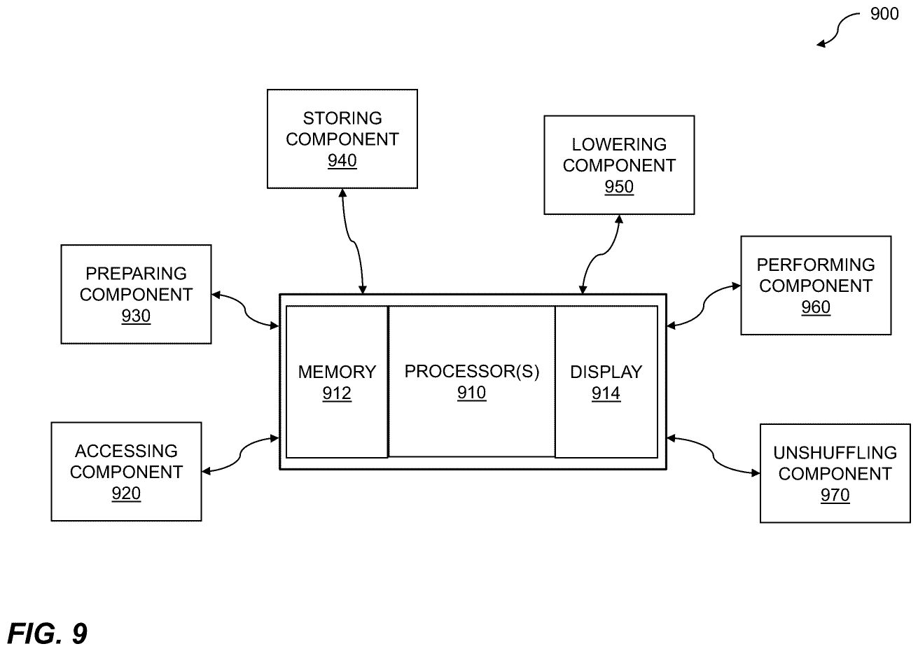

FIG. 9 is a system diagram for data manipulation. The data manipulation is enabled by local differential privacy using static random-access memory. The system 900 can include one or more processors 910, which are attached to a memory 912 which stores instructions. The system 900 can further include a display 914 coupled to the one or more processors 910 for displaying data, shuffled data, unshuffled data, permutation patterns, random key indices, linear feedback shift register results, and so on. In embodiments, one or more processors 910 are coupled to the memory 912, wherein the one or more processors, when executing the instructions which are stored, are configured to: access data for storage, wherein the data requires differential privacy data manipulation; prepare the data for storage, wherein the preparing comprises key-based shuffling; store the data that was shuffled in a static random-access memory (SRAM), wherein the SRAM comprises high-reliability storage cells and low-reliability storage cells; lower the supply voltage of the SRAM, wherein the lowering the supply voltage produces a pre-characterized noise level in the SRAM storage cells; perform a read of the data that was stored, wherein the random noise was injected to failed low-reliability storage cells; and unshuffle the data that was read, using key-based unshuffling. The keys used for the key-based shuffling and the key-based unshuffling comprise permutation patterns. The keys are selected for use by a random key index generator. The random key index generator is based on one or more linear feedback shift registers.

The system 900 can include an accessing component 920. The accessing component can access a variety of datatypes. The datatypes can include integer, real, floating-point, and character datatypes, and so on. The data can be accessed from a local computing device, local storage, remote storage, cloud storage, distributed storage, and the like. The data can require differential privacy to protect the data, obscure the data, conceal the data, etc. The system 900 can include a preparing component 930. The preparing component can prepare the data for storage. The preparing the data can be based on a variety of techniques such as local differential privacy (LDP) techniques. The preparing can comprise key-based shuffling. In embodiments, the key-based shuffling can be performed on a bit basis. A key used for the key-based shuffling can include a key from a plurality of keys. In embodiments, the keys can be generated outside of the SRAM. In embodiments, the keys used for the key-based shuffling can include permutation patterns.

Discussed below, the key selected for shuffling the data can be used for unshuffling the data. Selection of a key that can be used for preparing the data can be selected using a key index. The key index can include a random key index. In embodiments, the keys can be selected for use by a random key index generator. The key index generator can be based on a true random number generator, a pseudorandom number generator, etc. In embodiments, the random key index generator can be based on one or more linear feedback shift registers. Discussed previously and throughout, the data that is being prepared can be generated by a device such as an Internet of Things (IoT) device. Thus, the computational resources available to the IoT device can be modest or limited. In embodiments, the index can select a pre-calculated, stored key. The precalculated, stored key can include a key within a plurality of keys that can be stored on the IoT device, available to IoT device, etc. A variety of techniques can be used to apply the selected permutation patterns to the data. In embodiments, the permutation patterns are applied to data using a mux-based shuffler and/or unshuffler (discussed below).

The system 900 includes a storing device 940. The storing device can store the data that was shuffled in a static random-access memory (SRAM), wherein the SRAM comprises high-reliability storage cells and low-reliability storage cells. The high-reliability storage cells and the low-reliability storage cells can be implemented based on semiconductor device count, semiconductor device shape factors (e.g., width/length ratios), storage cell area, and so on. The high-reliability storage cells and the low-reliability cells can comprise substantially different numbers of semiconductor devices. In embodiments, the SRAM high-reliability storage cells can include eight-transistor (8T) storage cells and the SRAM low-reliability storage cells can include six-transistor (6T) storage cells. Each transistor within the high-reliability storage cells and within the low-reliability storage cells can be scaled to optimize read/write speed, storage cell stability, noise immunity, etc. The high-reliability storage cells and the low-reliability storage cells can be based on an SRAM topology that can include cross-coupled inverters, pass transistors, selection and data lines, etc. The SRAM cells can be used to store substantially similar data or substantially different data.

The system 900 includes a lowering component 950. The lowering component can lower the supply voltage of the SRAM. The lowering the supply voltage can include lowering the supply voltage by a fixed voltage, by a variable voltage, by voltage steps, and so on. The lowering the supply voltage can be used to enable failed SRAM cells, marginally passing SRAM cells, and the like. The lowering the supply voltage produces a pre-characterized noise level in the SRAM storage cells. Recall that SRAM operation is based on representing a logic 1 value and a logic 0 value. A successful read operation of an SRAM cell is based on being able to read the contents of an SRAM cell and determine that a read value corresponds to a logic 1 or a logic 0 value. When the supply voltage is lower, the difference in representations of logic 1 and logic 0 becomes less distinct and harder to differentiate. Thus, the lowering the supply voltage can enable use of the failed SRAM cells to inject “random noise” into data stored within the SRAM. The injection of the noise can enable one or more local data privacy (LDP) techniques. The lowering the supply voltage to the SRAM can further enable low-power data storage.

Embodiments can further include injecting random noise among the failed SRAM low-reliability cells based on the pre-characterized noise level. In embodiments, the random noise can be further generated by a random noise generator. The random noise generator can be used to introduce noise in the failed SRAM cells. The noise can be used to obscure the contents of the SRAM.

The system 900 includes a performing component 960. The performing component can perform a read of the data that was stored, wherein the read occurs across both high-reliability storage cells and low-reliability storage cells. The read of the data can be accomplished by providing an address associated with contents of the SRAM. The address can be provided to the SRAM using word lines. The contents of the SRAM at the address can be obtained using bitlines associated with the high-reliability storage cells and the low-reliability cells. The contents of the storage cells can include data that was prepared for storage using key-based shuffling. The data can be processed, stored, read, etc., based on a number of bits, bytes, words, and so on. In embodiments, the data can be processed, stored, read, and the like, on a byte basis. The bits associated with a byte can be stored using one or more of the high-reliability storage cells and the low-reliability storage cells. In embodiments, the high-reliability 8T cells can store four MSBs of a byte, and the low-reliability 6T cells can store the four LSBs of a byte. While a four-four storage bit pattern is described, other storage bit patterns can also be used.

The system 900 includes an unshuffling component 970. The unshuffling component can unshuffle the data that was read, using key-based unshuffling. The unshuffling can be used to restore the data to a state prior to the data being prepared for storage in the SRAM. The unshuffling can be accomplished using a key. In embodiments, the same key used for the key-based shuffling is used for the key-based unshuffling. The unshuffling can be performed on various bases. In embodiments, the key-based unshuffling can be performed on a bit basis. The key-based unshuffling can further be performed on a byte basis, a word basis, etc. The basis for the key-based unshuffling can be the same basis used for the key-based shuffling. In embodiments, the same key used for the key-based shuffling that is used for the key-based unshuffling is applied to a block of data. The unshuffling can be performed “in place”, where the unshuffling, cell flipping, etc. is performed on data within the storage cells. The data need not be transferred to a register or other temporary data storage in order to perform the unshuffling, cell flipping, etc.

The keys used for the shuffling and for the unshuffling can be stored using cells within the SRAM. In embodiments, keys used for the key-based shuffling and the key-based unshuffling can be stored in high-reliability storage cells. Use of the high-reliability storage cells can ensure that the keys remain unchanged by noise, cell flipping, etc. The use of the high-reliability storage cells can enable key stability, reliability, and so on. The key-based unshuffling can be accomplished within a processor, a storage element such as one or more registers, and the like. In embodiments, the key-based unshuffling can be performed within the SRAM. In other embodiments, the unshuffling can occur before presentation of the data to SRAM data terminals. Performing the unshuffling of data within the SRAM and prior to the presentation of the data can obscure observation of keys used for shuffling and unshuffling, random cell flipping, and so on. The obscuring can further enable the local differential privacy of data by reducing or eliminating observation of one or more LDP techniques.

The system 900 can include a computer program product embodied in a non-transitory computer readable medium for data manipulation, the computer program product comprising code which causes one or more processors to perform operations of: accessing data for storage, wherein the data requires differential privacy data manipulation; preparing the data for storage, wherein the preparing comprises key-based shuffling; storing the data that was shuffled in a static random-access memory (SRAM), wherein the SRAM comprises high-reliability storage cells and low-reliability storage cells; lowering the supply voltage of the SRAM, wherein the lowering the supply voltage produces a pre-characterized noise level in the SRAM storage cells; performing a read of the data that was stored, wherein the read occurs with random noise injected in failed cells; and unshuffling the data that was read, using key-based unshuffling.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random-access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for data manipulation comprising:
accessing data for storage, wherein the data requires differential privacy data manipulation;
preparing the data for storage, wherein the preparing comprises key-based shuffling;
storing the data that was shuffled in a static random-access memory (SRAM), wherein the SRAM comprises high-reliability storage cells and low-reliability storage cells;
lowering a supply voltage of the SRAM, wherein the lowering a supply voltage produces a pre-characterized noise level in the SRAM storage cells;
performing a read of the data that was stored; and
unshuffling the data that was read, using key-based unshuffling.

2. The method of claim 1 wherein the high-reliability storage cells are used to store most-significant bits (MSB) and keys and the low-reliability storage cells are used to inject random noise.

3. The method of claim 1 wherein keys used for the key-based shuffling and the key-based unshuffling comprise permutation patterns.

4. The method of claim 3 wherein the keys are selected for use by a random key index generator.

5. The method of claim 4 wherein the random key index generator is based on one or more linear feedback shift registers.

6. The method of claim 4 wherein the index selects a pre-calculated, stored key.

7. The method of claim 3 wherein the permutation patterns are applied to data using a mux-based shuffler and/or unshuffler.

8. The method of claim 1 wherein a same key used for the key-based shuffling is used for the key-based unshuffling.

9. The method of claim 8 wherein the same key used for the key-based shuffling that is also used for the key-based unshuffling is applied to a block of data.

10. The method of claim 1 wherein keys used for the key-based shuffling and the key-based unshuffling are stored in high-reliability storage cells.

11. The method of claim 10 wherein the keys are generated outside of the SRAM.

12. The method of claim 1 wherein the key-based shuffling is performed on a bit basis.

13. The method of claim 1 wherein the key-based unshuffling is performed on a bit basis.

14. The method of claim 1 wherein the high-reliability storage cells are used to store most significant bits (MSBs).

15. The method of claim 14 wherein the low-reliability storage cells are used to store least significant bits (LSBs).

16. The method of claim 15 wherein the data is processed on a byte basis.

17. The method of claim 16 wherein the high-reliability storage cells store the four MSBs of a byte.

18. The method of claim 16 wherein the low-reliability storage cells store the four LSBs of a byte.

19. The method of claim 1 further comprising injecting noise among the low-reliability cells, based on the pre-characterized noise level.

20. The method of claim 19 wherein the injecting noise is further controlled by a random noise generator.

21. The method of claim 20 wherein the random noise generator is used to provide a random value for the low-reliability cells.

22. The method of claim 1 wherein the key-based unshuffling is performed during operation of the SRAM.

23. The method of claim 22 wherein the unshuffling occurs before presentation of the data to SRAM data terminals.

24. A computer program product embodied in a non-transitory computer readable medium for data manipulation, the computer program product comprising code which causes one or more processors to perform operations of:
accessing data for storage, wherein the data requires differential privacy data manipulation;
preparing the data for storage, wherein the preparing comprises key-based shuffling;
storing the data that was shuffled in a static random-access memory (SRAM), wherein the SRAM comprises high-reliability storage cells and low-reliability storage cells;
lowering a supply voltage of the SRAM, wherein the lowering a supply voltage produces a pre-characterized noise level in the SRAM storage cells;
performing a read of the data that was stored; and
unshuffling the data that was read, using key-based unshuffling.

25. A computer system for data manipulation comprising:
a memory which stores instructions;
one or more processors coupled to the memory, wherein the one or more processors, when executing the instructions which are stored, are configured to:
access data for storage, wherein the data requires differential privacy data manipulation;
prepare the data for storage, wherein the preparing comprises key-based shuffling;
store the data that was shuffled in a static random-access memory (SRAM), wherein the SRAM comprises high-reliability storage cells and low-reliability storage cells;
lower a supply voltage of the SRAM, wherein the lowering a supply voltage produces a pre-characterized noise level in the SRAM storage cells;
perform a read of the data that was stored; and
unshuffle the data that was read, using key-based unshuffling.
